(19) United States
(12) Patent Application Publication
(10) Pub. No.: US 2026/0048697 A1
(43) Pub. Date: Feb. 19, 2026

(54) FLUID SERVICE ASSEMBLY FOR A SERVICE VEHICLE

(71) Applicant: EQUIPMENTSHARE.COM INC, COLUMBIA, MO (US)

(72) Inventors: JORDAN BOULDEN, COLUMBIA, MO (US); MICHAEL MORRIS, COLUMBIA, MO (US); BRIAN ADAMS, COLUMBIA, MO (US)

(21) Appl. No.: 18/808,509

(22) Filed: Aug. 19, 2024

(51) Int. Cl. B60P 3/22

(52) U.S. Cl. CPC B60P 3/2215; B60P 3/225; B60P 3/2265; B60P 3/228; B60P 3/2295

(57) ABSTRACT

A service vehicle includes a service truck with a truck bed and a fluid service assembly. The fluid service assembly includes a fluid service module supported by the bed and a hose reel assembly. The fluid service module includes a housing, a first fluid tank, a first fluid pump, a waste fluid tank, and a waste fluid pump. The first fluid tank is removeably attached to the housing. The first fluid pump pumps the fluid out of the first fluid tank. The waste fluid tank has a waste fluid interior for containing a waste fluid. The waste fluid pump pumps the waste fluid into and out of the waste fluid tank. The hose reel assembly is coupled to the service truck independent of the fluid service module. The hose reel assembly includes a hose reel receives the fluid pumped by the first fluid pump.

### FIELD

The present disclosure generally relates to fluid service assemblies for service vehicles, and, more specifically, to fluid service assemblies for delivering and removing fluids.

### BACKGROUND

Service or utility vehicles, such as trucks, include fluid service assemblies for refilling and/or replacing fluids in pieces of equipment. Such service vehicles are often used in construction, mining, oil and gas, and equipment rental applications to service equipment out in the field. The fluid service assembly carried by the service vehicle is also known as a “lubeskid” or “lube skid.”

### SUMMARY

In one aspect, a service vehicle comprising a service truck having a truck bed. The service vehicle also comprising a fluid service assembly comprising a fluid service module supported by the truck bed of the service truck. The fluid service module includes a housing, a first fluid tank, a first fluid pump, a waste fluid tank, and a waste fluid pump. The first fluid tank is removeably attached to the housing and has a first interior configured to contain a first fluid. The first fluid pump is supported by the housing. The first fluid pump is configured to pump the first fluid out of the first interior of the first fluid tank. The waste fluid tank has a waste fluid interior configured to contain a waste fluid. The waste fluid pump is associated with the waste fluid tank. The waste fluid pump is supported by the housing. A hose reel assembly is coupled to the service truck independent of the fluid service module. The hose reel assembly includes a first hose reel fluidly connected to the first fluid pump to receive the first fluid pumped by the first fluid pump.

In another aspect, a fluid service module comprising a housing including a fluid tank interior and a shroud bounding the fluid tank interior. A first fluid tank is disposed in the fluid tank interior and is supported by the housing. The first fluid tank has a first interior configured to contain a first fluid. A first fluid pump is attached to the housing. The first fluid pump is configured to pump the first fluid out of the first interior of the first fluid tank. The shroud is releasably connectable to a remainder of the housing such that when the shroud is connected to the remainder of the housing the shroud secures the first fluid tank in the fluid tank interior of the housing and when the shroud is disconnected from the remainder of the housing the first fluid tank is removeable from the fluid tank interior of the housing.

In another aspect, a fluid service module comprising a housing including a fluid tank interior and a shroud bounding the fluid tank interior. The housing forms a waste fluid tank. A first fluid tank is disposed in the fluid tank interior and is supported by the housing. The first fluid tank has a first interior configured to contain a first fluid. The first fluid tank is translucent or transparent. A first fluid pump is attached to the housing. The first fluid pump is configured to pump the first fluid out of the first interior of the first fluid tank. A second fluid tank is disposed in the fluid tank interior and is supported by the housing. The second fluid tank has a second interior configured to contain a second fluid. The second fluid tank is translucent or transparent. A second fluid pump is attached to the housing. The second fluid pump is configured to pump the second fluid out of the second interior of the second fluid tank. A third fluid tank is disposed in the fluid tank interior and is supported by the housing. The third fluid tank has a third interior configured to contain a third fluid. The third fluid tank is translucent or transparent. A third fluid pump is attached to the housing. The third fluid pump is configured to pump the third fluid out of the third interior of the third fluid tank. A waste fluid pump is configured to pump waste fluid into and out of the waste fluid tank. The shroud is releasably connectable to a remainder of the housing such that when the shroud is connected to the remainder of the housing the shroud secures the first, second, and third fluid tanks in the fluid tank interior of the housing and when the shroud is disconnected from the remainder of the housing the first, second, and third fluid tanks are removeable from the fluid tank interior of the housing. The shroud bounds at least two of the following: a first side of the fluid tank interior, a second side of the fluid tank interior, a rear of the fluid tank interior, or a top of the fluid tank interior. The housing includes a first window arranged to permit an operator to view a level of the first fluid in the first fluid tank, a second window arranged to permit the operator to view a level of the second fluid in the second fluid tank, and a third window arranged to permit the operator to view a level of the third fluid in the third fluid tank.

In another aspect, a method comprises disconnecting a shroud from a remainder of a housing of a fluid service module to access a first fluid tank configured to contain a first fluid; removing, after said disconnecting, the first fluid tank from a fluid tank interior of the housing; placing, after said removing, a second fluid tank in the fluid tank interior, the second fluid tank occupying a space in the fluid tank interior occupied by the first fluid tank before the first fluid tank was removed from the fluid tank interior; and reconnecting, after said placing, the shroud to the remainder of the housing of the fluid service module to secure the second fluid tank in the fluid tank interior.

Other objects and features of the present disclosure will be in part apparent and in part pointed out herein.

### BRIEF DESCRIPTION OF THE DRAWINGS

FIG. 1 is a perspective of a service vehicle with a fluid service assembly according to one embodiment of the present disclosure;

FIG. 2 is a front perspective of a fluid service module of the fluid service assembly according to one embodiment of the present disclosure;

FIG. 3 is a rear perspective of the fluid service module of FIG. 2;

FIG. 4 is a cross-sectional view of the fluid service module of FIG. 2, taken through line 4-4 in FIG. 3;

FIG. 5 is a partially exploded view of the fluid service module of FIG. 2;

FIG. 6 is a schematic plumbing diagram of the fluid service assembly;

FIG. 7 is a rear perspective of a fluid service module according to another embodiment of the present disclosure;

FIG. 8 is a partially exploded view of the fluid service module of FIG. 7;

FIG. 9 is a cross-sectional view of the fluid service module of FIG. 7, taken through line 9-9 in FIG. 7;

FIG. 10 is a rear perspective of a fluid tank of the fluid service module of FIG. 7; and

FIG. 11 is a front perspective of the fluid tank of FIG. 10.

Corresponding reference characters indicate corresponding parts throughout the drawings.

### DETAILED DESCRIPTION

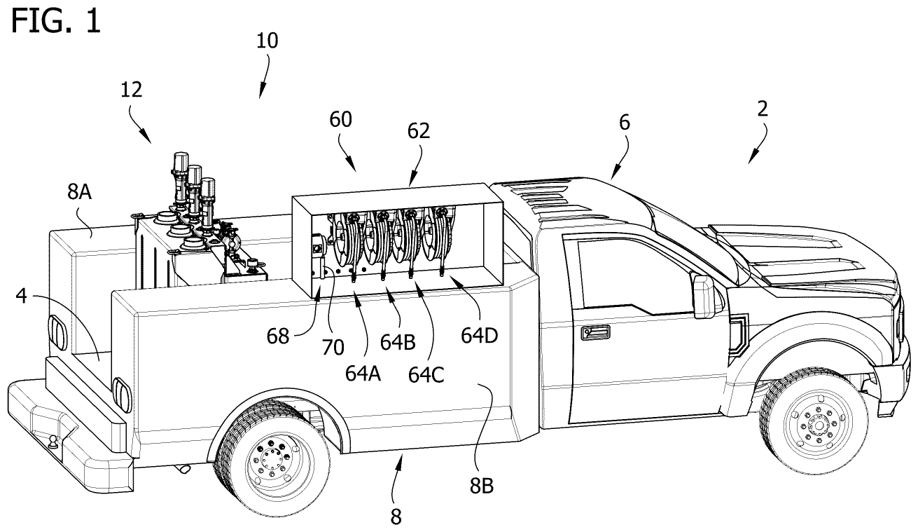

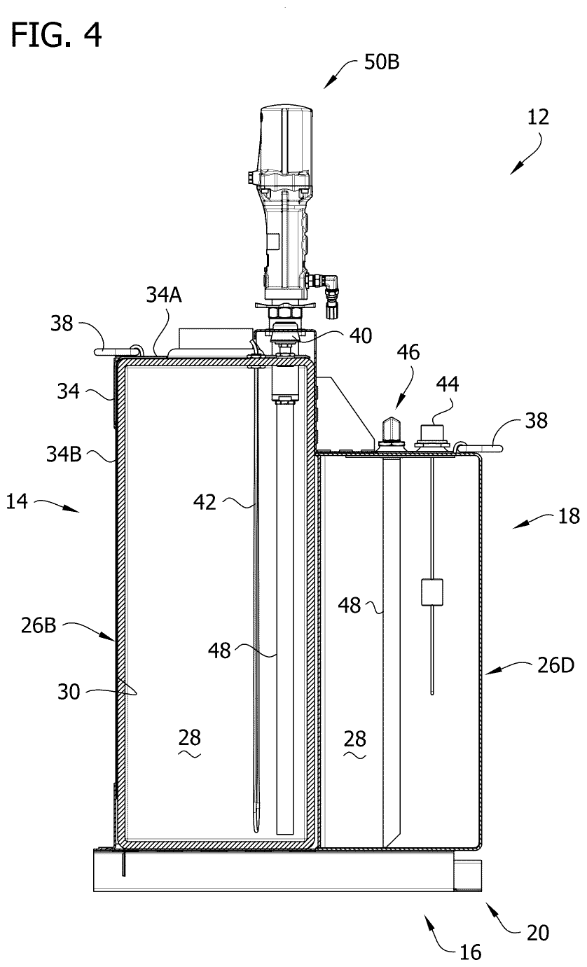

Referring to FIGS. 1-6, one embodiment of a fluid service assembly according to the present disclosure is generally indicated at reference numeral 10. The fluid service assembly 10 holds and transports fluids, such as oils, water, antifreeze, lubricants, grease, hydraulic and the like. For example, the fluid service assembly 10 can be used to deliver and supply these fluids to different types of machinery in the field, such as construction equipment, mining equipment, etc., as needed. Further, the fluid service assembly 10 can be sued to remove fluids from the equipment as well. As shown in FIG. 1, fluid service assembly 10 can be carried by a service vehicle. In the illustrated embodiment, the service vehicle comprises a service truck 2 although other types of vehicles can be used to transport the fluid service assembly without departing from the scope of the present disclosure. The service truck 2 includes a truck bed 4, a cab 6, and a body 8 having opposite left and right fender portions 8A, 8B. The fender portions 8A, 8B are disposed on opposite sides of and extend generally the length of the truck bed 4. In some embodiments, the one or both of the fender portions may include boxes, cabinets, and/or drawers for holding various pieces of equipment, hardware, and/or tools. Other service vehicle configurations may be used without departing from the scope of the present disclosure.

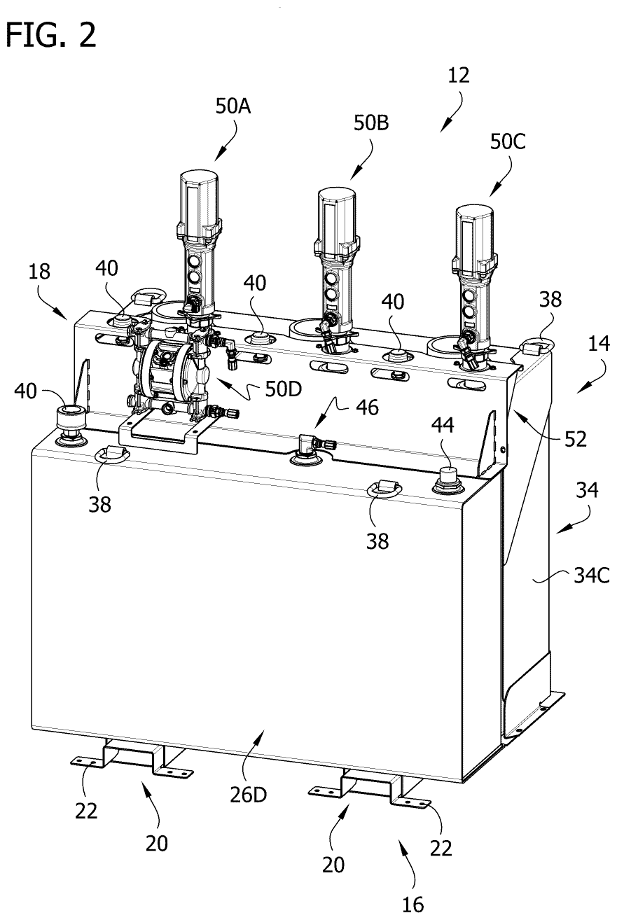

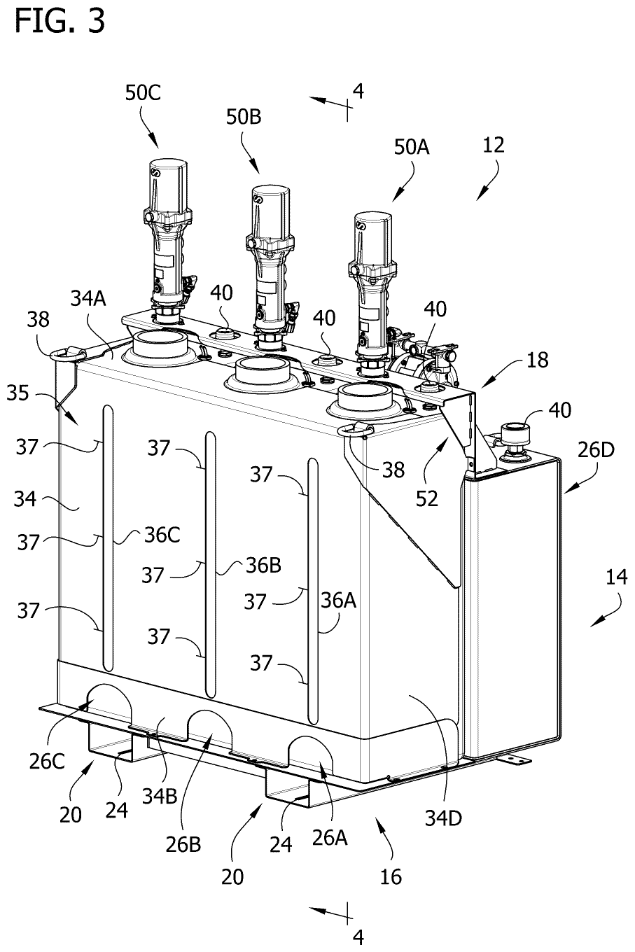

The fluid service assembly 10 includes a fluid service module 12. The fluid service module 12 is a self-contained unit. The fluid service module 12 includes a housing or framework 14. The housing 14 includes a base or platform 16 and a support structure 18 extending upward from the base 16. In the illustrated embodiment, the housing 14 is generally formed of multiple panels (e.g., sheet metal panels) joined together, such as by welding or with fasteners, although other configurations can be used without departing from the scope of the present disclosure. The fluid service module 12 (e.g., the housing 14) is sized and shaped to fit in the truck bed 4 of the service truck 2. This way, the fluid service module 12 is supported and carried by the truck bed 4 of the service truck 2. The base 16 of the housing 14 includes forklift skids or runners 20 for receiving the forks of a forklift (not shown) for placing and removing the fluid service module 12 in the truck bed 4. The base 16 (e.g., forklift skids 20) may also include one or more than one hole 22 (FIG. 2) and/or one or more than one slot 24 (FIG. 3) for receiving one or more than one fastener, such as bolts or screws, to secure the fluid service module 12 to the truck bed 4 (broadly, the service truck 2). Other ways of securing the fluid service module 12 to the service truck 2 may be used without departing from the scope of the present disclosure. The fluid service module 12 can be placed generally anywhere along the length of the truck bed 4. For example, in the illustrated embodiment, the fluid service module 12 is positioned toward the rear of the truck bed 4. In another embodiment, the fluid service module 12 is positioned forward on the truck bed 4, against the rear of the cab 6.

The fluid service module 12 includes one or more than one fluid tank, container, or vessel for holding a fluid. In the illustrated embodiment, the fluid service module 12 includes four fluid tanks 26A-D, although the fluid service module may include more or fewer fluid tanks without departing from the scope of the present disclosure. Each tank 26A-D has an interior 28 configured to contain a fluid (e.g., a first fluid, a second fluid, etc.). The fluid tanks 26A-D are supported by the housing 14. One or more than one of the fluid tanks 26A-D is removeably attached to the housing 14. In the illustrated embodiment, three fluid tanks 26A-C are removeably attached to the housing 14. In some embodiments, these three removeable fluid tanks 26A-C are made of plastic, such as polyethylene. In some embodiments, the removeable fluid tanks 26A-D are translucent or transparent, to permit a user to view the fluid (e.g., level thereof) therein. The housing 14 defines a fluid tank interior 30 sized and shaped to receive the removeable fluid tanks 26A-C. The platform 16 includes an upper tank support surface 32 upon which the removeable fluid tanks 26A-C rest on when disposed in the fluid tank interior 30. The removeable fluid tanks 26A-C are aligned in a row when disposed in the fluid tank interior 30 of the housing 14. The removeable fluid tanks 26A-C may be considered fresh or supply fluid tanks, as in operation these fluid tanks will hold fluid to be supplied by the fluid service assembly 10 to the equipment being serviced. In the illustrated embodiment, the fourth fluid tank 26D is formed by the housing 14, specifically, a set of panels thereof. Thus, the fourth fluid tank 26D is not removeable from the housing 14. The fourth fluid tank 26D is disposed in front of the fluid tank interior 30 (a rear wall or panel of the fourth fluid tank bounds the front of the fluid tank interior). The fourth fluid tank 26D also rests on the upper tank support surface 32 of the platform 16. The fourth fluid tank 26D may be considered a waste fluid tank, as in operation this fluid tank will hold waste fluid removed from the equipment being serviced.

To removeably secure the removeable fluid tanks 26A-C to the housing 14, the housing includes a shroud 34. The shroud 34 bounds the fluid tank interior 30. The shroud 34 bounds one or more than one of the following: a first side of the fluid tank interior 30, a second side of the fluid tank interior, a rear of the fluid tank interior, or a top of the fluid tank interior. In some embodiments, the shroud 34 bounds at least two of the following: a first side of the fluid tank interior 30, a second side of the fluid tank interior 30, a rear of the fluid tank interior 30, or a top of the fluid tank interior 30. In the illustrated embodiment, the shroud 34 bounds a first side of the fluid tank interior 30, a second side of the fluid tank interior, a rear of the fluid tank interior, and a top of the fluid tank interior. The shroud 34 includes a top wall 34A bounding the top of the fluid tank interior 30, a rear wall 34B bounding the rear of the fluid tank interior, a left or first side wall 34C bounding a first side of the fluid tank interior, and a right or second side wall 34D bounding a second side of the fluid tank interior. In the illustrated embodiment, the shroud 34 is an integral unit of panels joined together, such as by welding and/or bends, although other configurations may be used without departing from the scope of the present disclosure. The top wall 34A may include openings or cutouts corresponding to the mouths of the removeable fluid tanks 26A-C, to allow the mouths of the fluid tanks to extend through the top wall. Removable caps or lids (not shown) are attached to (e.g., screwed on) the mouths of the fluid tanks 26A-C. This arrangement allows the fluid tanks 26A-C to be refilled with fluid, without removing the shroud 34.

In the illustrated embodiment, the housing 14 substantially surrounds and covers the removeable fluid tanks 26A-C. This prevents the removeable fluid tanks from being damaged. In some embodiments, the housing 14 surrounds and covers at least 50% of the exterior surface area of the removeable fluid tanks 26A-C. In some embodiments, the housing 14 surrounds and covers at least 75% of the exterior surface area of the removeable fluid tanks 26A-C. In some embodiments, the housing 14 surrounds and covers at least 90% of the exterior surface area of the removeable fluid tanks 26A-C.

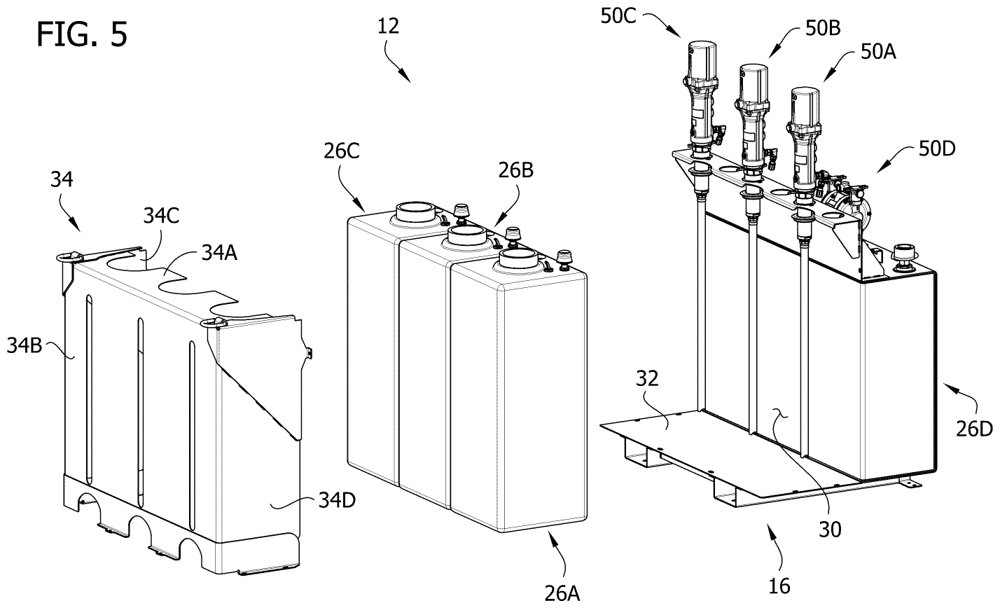

The shroud 34 is releasably connectable to the reminder of the housing 14 (the remainder of the housing 14 including any part of the housing 14 that is not the shroud 34, such as the platform 16 and the support structure 18). In the illustrated embodiment, the shroud 34 is releasably connectable to the platform 16 and the support structure 18. In the illustrated embodiment, the shroud 34 is releasably connected to the remainder of the housing 14 with multiple fasteners (e.g., bolts), although other ways may be used without departing from the scope of the present disclosure. The shroud 34 includes mounting tabs or flanges which have openings for receiving the fasteners. Some of the mounting tabs overlap the platform 16 and some of the mounting tabs overlap other portions of the support structure 18. When the shroud 34 is connected to the rest of the housing 14, the shroud 34 secures the removeable fluid tanks 26A-C in the fluid tank interior 30 of the housing 14. When the shroud 34 is disconnected (FIG. 5) from the remainder of the housing 14, the removeable fluid tanks 26A-C are free to be removed from the fluid tank interior 30 of the housing 14.

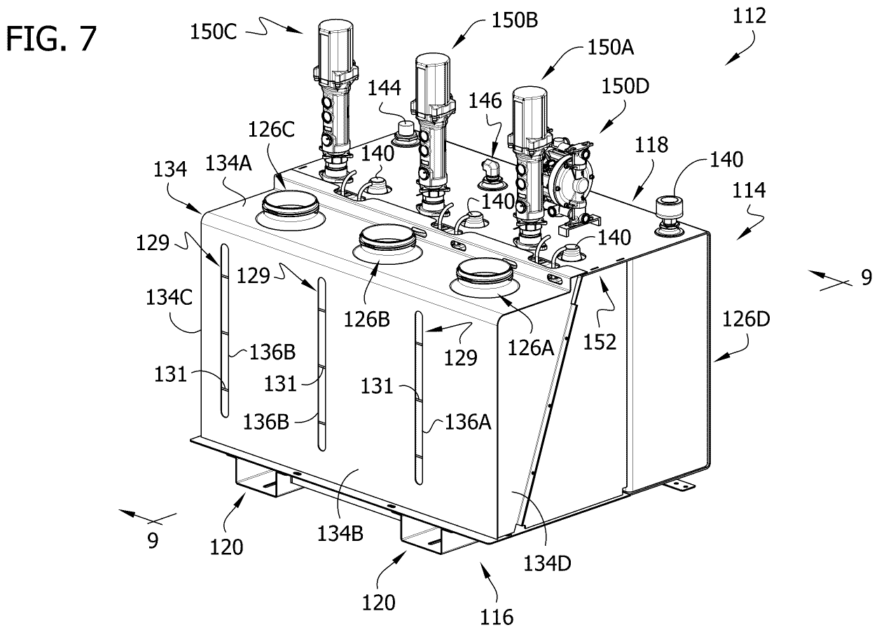

The shroud 34 (broadly, the housing 14) may include multiple windows 36A-C (FIG. 3). Each window 36A-C is associated with one of the removeable fluid tanks 26A-C. Each window 36A-C is arranged to permit an operator or user to view a level of the fluid in the associated fluid tank 26A-C. Each window 36A-C is generally elongate and extends along the height of the fluid tank 26A-C. In some embodiments, each window 36A-C extends over at least a majority of the height of the associated fluid tank 26A-C, and in some embodiments, at least 75% of the height of the associated fluid tank. In the illustrated embodiment, the rear wall 34B defines the windows 36A-C. The shroud 34 may also include fill level indicia 35 (FIG. 3) for visually indicating to an operator or user the amount or level of fluid within each fluid tank 26A-C. Each fill level indicia 35 is associated with one of the windows 36A-C in the shroud 34 (FIG. 7). This allows the operator to quickly visually determine the amount of fluid in the fluid tanks 26A-C. In the illustrated embodiment, the fill level indicia 35 comprises multiple vertically spaced apart marks 37 (e.g., horizontal lines). Three marks 37 are employed for each window 36A-C, a lower mark 37 indicating ¼ full, a middle mark indicating ½ full, and an upper mark indicating ¾ full. More or fewer marks, and/or marks indicating other levels of full may be used without departing from the scope of the present disclosure. The marks 37 are disposed on the rear wall 34B of the shroud 34. The marks 37 may be formed by any suitable method, such as by etching, cutting (e.g., laser cutting), paint, stickers, etc.

The housing 14 may include lift points for lifting, such as with the crane, the fluid service module 12. In the illustrated embodiment, the housing 14 includes four lifting points defined by lifting rings 38. Two lifting rings 38 are attached to the shroud 34 and another two lifting rings 38 are attached to the top of the fourth fluid tank 26D. The shroud 34 may be reinforced at the lifting rings 38 in order to support the weight of the fluid service module 12 (and any fluid held by the fluid tanks 26A-D). In the illustrated embodiment, the reinforcement includes additional panels (e.g., sheet metal panels) for transferring the load from the lifting rings 38 to the remainder of the housing 14 to which the shroud is connected. Other manners of reinforcement may be used without departing from the scope of the present disclosure.

Each of the fluid tanks 26A-D includes a breather cap or vent 40 which can permit air to flow into the associate fluid tank when fluid is being pumped out of the fluid tank and/or permit air to flow out of the fluid tank when fluid is being pumped into the fluid tank. The fluid service module 12 may include one or more than one heater for heating the fluid contained within the fluid tanks 26A-D. In the illustrated embodiment, the removeable fluid tanks 26A-C each include a heater 42 disposed in the interior 28. The heater 42 may be an electrical resistance heater connected to the service vehicle's 2 electrical power system. Desirably, at least a portion of the heater 42 is adjacent the bottom of the removeable fluid tanks 26A-C. In the illustrated embodiment, the heater 42 extends nearly the full height of the interior 28. The fourth fluid tank 26D may also include a heater in its interior 28. Other configurations of the heater(s) may be used without departing from the scope of the present disclosure. For example, one or more than one heater may be arranged outside the fluid tanks 26A-D for heating the fluid tanks. In another example, a heated fluid such as engine coolant or hydraulic fluid from the service truck 2 may be used to heat the fluid in the fluid, such as by flowing through a conduit within and/or around the fluid tanks 26A-D. In another example, the fluid service module 12 may include a heating pad under the fluid tanks 26A-D. In some embodiments, the fluid service module 12 may include insulation surrounding the fluid tanks 26A-D, such as between the removeable fluid tanks 26A-C and the housing 14 (such as the shroud 34) and/or on the outside of the housing (such as the shroud), to prevent heat transfer with the ambient environment.

The fourth fluid tank 26D may also include a level gauge 44 for indicating the level of fluid in the fourth fluid tank. The fourth fluid tank 26D also includes a fluid port 46 for permitting fluid to flow into and out of the fourth fluid tank. The fluid port 46 includes a fitting configured to connect to a hose or conduit. Extending downward from the fluid port 46 in the fourth fluid tank 26D is a tube 48 which ends near the bottom of the interior 28, to deliver fluid to the bottom of the interior and draw fluid from the bottom of the interior.

The fluid service module 12 includes a pump assembly for moving fluid out of and/or into the fluid tanks 26A-D. To prevent cross-contamination between the different fluids, the pump assembly includes one or more than one fluid pump 50A-D, each fluid pump associated with one of the fluid tanks 26A-D. The fluid pumps 50A-D are supported by and attached to the housing 14, specifically a pump mount or support 52 of the support structure 18. The fluid pumps 50A-D may be electrically operated, hydraulically operate, or pneumatically operated. The fluid pumps 50A-D can be connected to the corresponding system of the service truck 2 (e.g., electrical system, hydraulic system, or pneumatic system) for powering the fluid pumps. The three fluid pumps 50A-C associated with the removeable fluid tanks 26A-C each pump fluid out of the interior 28 of their respective fluid tank. These three fluid pumps 50A-C each include a tube 48 which extends downward into the fluid tank and ends near the bottom of the interior 28, to draw fluid from the bottom of the interior. The three fluid pumps 50A-C can be disconnected to the pump mount 52 and the tubes 48 removed from the fluid tanks 26A-C in order to remove the fluid tanks from the fluid tank interior 30. The pump mount 52 also includes oversized openings that receive the breather caps 40 and permit the fluid tanks 26A-C to be removed and positioned in the fluid tank interior 30 by sliding and angling the fluid tanks. The three fluid pumps 50A-C associated with the removeable fluid tanks 26A-C may be considered fresh or supply fluid pumps, as in operation these fluid pumps will pump fresh fluid to the equipment. The fluid pump 50D associated with the fourth fluid tank 26D may be considered a waste fluid pump, as in operation this fluid pump with pump waste fluid to and from (e.g., into and out of) the fourth (e.g., waste) fluid tank.

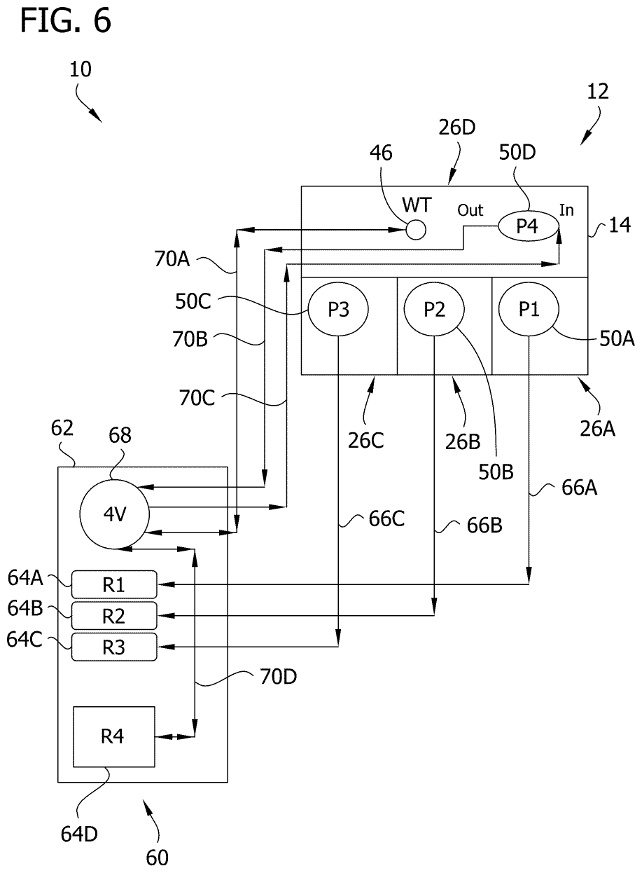

Referring to FIGS. 1 and 6, the fluid service assembly 10 includes a hose reel assembly 60. The hose reel assembly 60 is separate or independent from the fluid service module 12. The hose reel assembly 60 includes a hose reel housing or box 62 and one or more than one hose reel 64A-D housed or contained in the hose reel housing. To prevent cross-contamination between the different fluids, in the illustrated embodiment the hose reel assembly 60 includes four hose reels 64A-D (e.g., a first hose reel, a second hose reel, etc.), with each hose reel associated with one of the fluid pumps 50A-D and its associated fluid tank 26A-D. The operator uses the hose reels 64A-D to deliver fluid to the equipment and/or remove fluid from the equipment. The hose reel assembly 60 (specifically, the hose reel housing 62) is coupled or mounted to the service truck 2 independent of the fluid service module 12. This allows the hose reel assembly 60 (and the hose reels 64A-D thereof) to be located at a convenient location on the service truck 2, such as along a side of the truck bed 4 (FIG. 1) (instead of in the truck bed). For example, the hose reel assembly 60 can be mounted to one of the fender portions 8A, 8B of the service truck 2 and face outward. This enables an operator to easily access the hose reels 64A-D without having to enter the service truck 2, such as by climbing into the truck bed 4. Thus, the fluid service module 2 is free of any hose reels. Some conventional fluid service assemblies often include the hose reels as part of the fluid service module, hereby requiring an operator to climb up into the truck bed in order to access to the hose reels. Other conventional fluid service assemblies position the hose reels at the rear end of the truck bed, thereby block access to the truck bed.

The plumbing of the fluid service assembly 10 will be described with reference to FIG. 6. In general, each hose reel 64A-D is fluidly connected to one of the fluid pumps 50A-D. The first hose reel 64A is fluidly connected to the first fluid pump 50A to receive (broadly, carry) the fluid pumped by the first fluid pump from the first fluid tank 50A. The second hose reel 64B is fluidly connected to the second fluid pump 50B to receive the fluid pumped by the second fluid pump from the second fluid tank 50B. The third hose reel 64C is fluidly connected to the third fluid pump 50C to receive the fluid pumped by the third fluid pump from the third fluid tank 50C. The fourth hose reel 64D is fluidly connected to the fourth fluid pump 50D to carry the fluid pumped by the fourth fluid pump to and from the fourth fluid tank 50D. The plumbing of fluid service assembly 10 includes a first fluid supply conduit or hose 66A extending from the first fluid pump 50A to the first hose reel 64A, a second fluid supply conduit or hose 66B extending from the second fluid pump 50B to the second hose reel 64B, and a third fluid supply conduit or hose 66C extending from the third fluid pump 50C to the third hose reel 64C.

The plumbing may also include a reversing valve 68 (e.g., a four-way valve) used to control the direction of fluid flow with respect to the fourth fluid tank 26D. The reversing valve 68 (broadly, a flow direction controller) allows the fourth fluid pump 50D to pump fluid into the fourth fluid tank 26D and out of the fourth fluid tank 26D. The reversing valve 68 is contained in the hose reel box 62 (for easy access same as the hose reels), although other positions of the reversing valve may be used without departing from the scope of the present disclosure. For example, the reversing valve may be positioned on (carried by) the fluid service module 12, such as on the pump mount 52. The reversing valve 68 includes a manually operable actuator or handle 70 that allows an operator to control the flow direction of the fluid into or out of the fourth fluid tank 26D. Using the actuator 70, the operator places the reversing valve 68 in one configuration so that the fourth fluid pump 50D pumps fluid out of the fourth fluid tank 26D and out of the fourth hose reel 64D, or in another configuration so that the fourth fluid pump draws fluid through the fourth hose reel and pumps the fluid into the fourth fluid tank 26D. This allows the operator to both fill the fourth fluid tank 26D, such as by removing old or waste fluid from the equipment being serviced, and empty the fourth fluid tank 26D, such as to discard the waste fluid. The plumbing includes a first waste conduit or hose 70A extending from the fluid port 46 of the fourth fluid tank 26D to the reversing valve 68, a second waste conduit or hose 70B extending from the outlet of the fourth fluid pump 50D to the reversing valve, a third waste conduit or hose 70C extending from the inlet of the fourth fluid pump to the reversing valve, and a fourth waste conduit or hose 70D extending from the reversing valve to the fourth hose reel 64D. Other ways of controlling the flow direction of the fluid may be used without departing from the scope of the present disclosure.

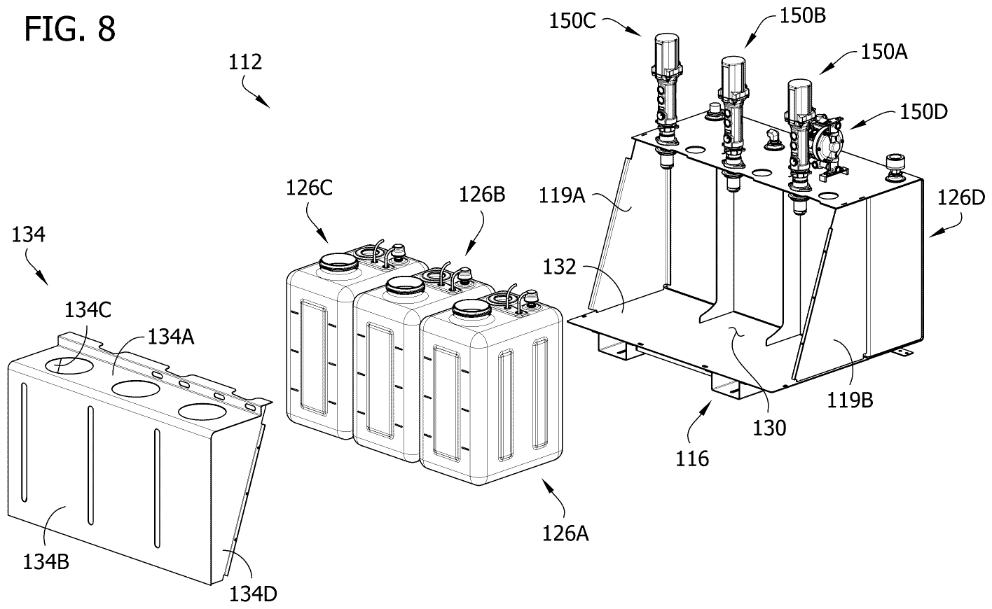

Referring to FIGS. 7-11, another embodiment of a fluid service module according to the present disclosure for the fluid service assembly 10 is generally indicated by reference numeral 112. The fluid service module 112 of FIGS. 7-11 is generally analogous to the fluid service module 12 of FIGS. 1-6, and thus, for ease of comprehension, where similar, analogous or identical parts are used, identical reference numerals “100” units higher are employed. Accordingly, unless clearly stated or indicated otherwise, the above descriptions regarding the fluid service module 12 of FIGS. 1-6 also apply to the fluid service module 112 of FIGS. 7-11.

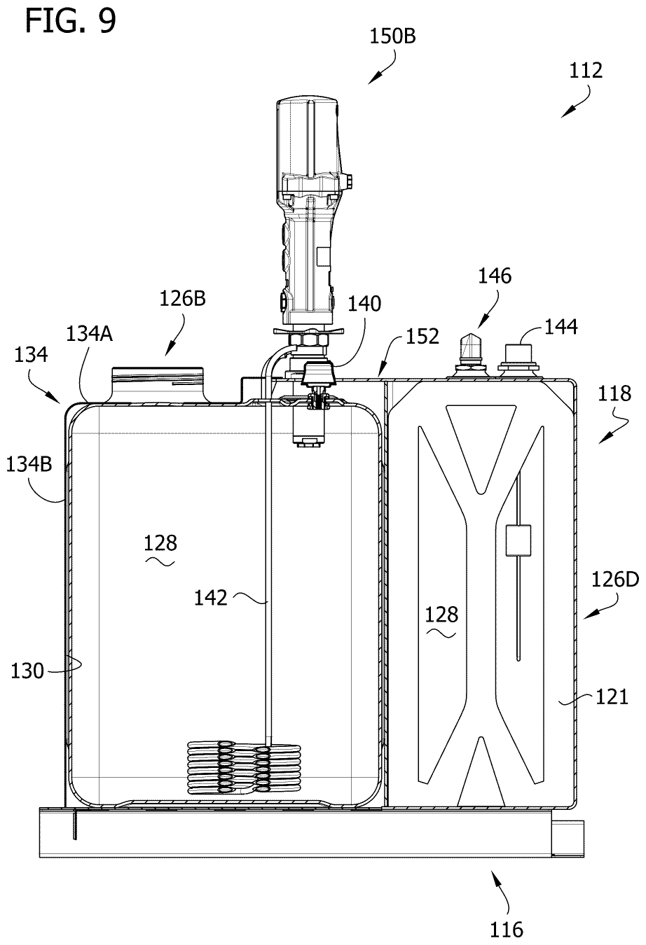

In this embodiment, the height of the fluid service module 112 is less than the height of the fluid service module 12 of FIGS. 1-6. This reduced height prevents the fluid service module 112 from visually blocking elements of the service truck 2, such as a rear window of the cab 6 and/or service lights on top of the cab, when the fluid service module is disposed in the bed 4. To facilitate this reduced height, the height of the fluid tanks 126A-D are reduced from the fluid tanks 26A-D of FIGS. 1-6. Further, the pump support 152 in this embodiment includes an upper wall of the housing 114 (specifically, support structure 118) that also forms part of the fourth fluid tank 126D (e.g., bounds the top of the interior 128 thereof). In this embodiment, the support structure 118 includes left and right (e.g., first and second) side walls 119A, 119B that bound forward portions of opposite left and right sides of the fluid tank interior 130. Together, the left and right side walls 119A, 119B of the support structure 118 and the left and right side walls 134C, 134D of the shroud 134 bound the opposite left and right sides of the fluid tank interior 130, when the shroud is attached to the remainder of the housing 114. The left and right side walls 119A, 119B of the support structure 118 and the left and right side walls 134C, 134D of the shroud 134 are releasably fastened together along an interface extending at a skew or forwardly inclined angle relative to the vertical. In this embodiment, the heaters 142 (FIG. 9) include a coiled lower portion for heating the fluid in the lower portion of the fluid tanks 126A-C. The support structure 118 may also include a brace 121 (FIG. 9) in the fourth fluid tank 126D to provide additional support.

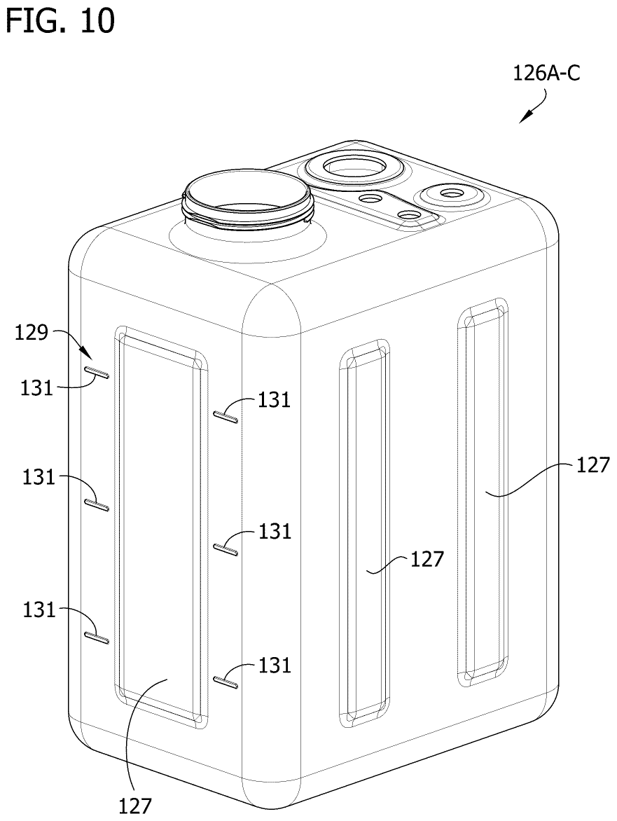

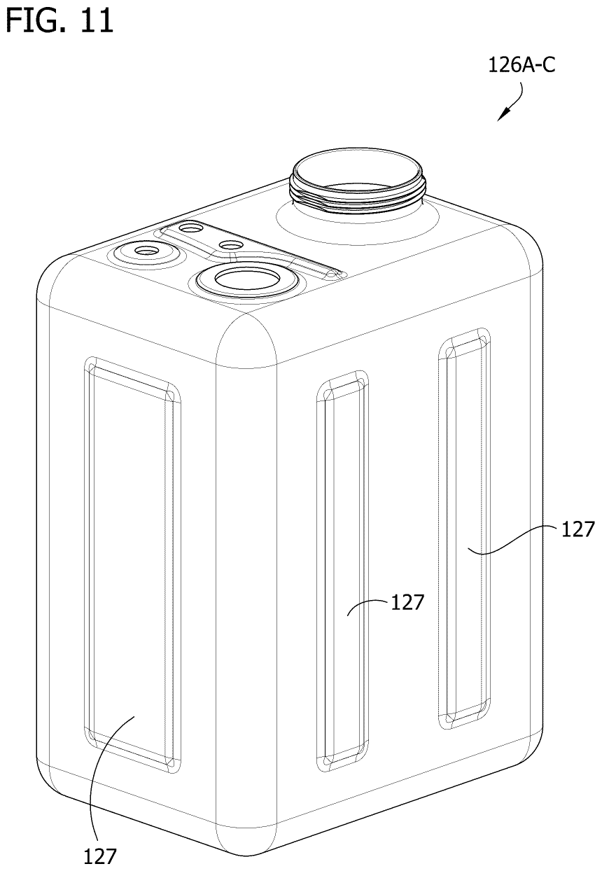

Referring to FIGS. 10 and 11, the removeable fluid tanks 126A-C in this embodiment include some additional features. One or more than one side of the fluid tanks 126A-C include one or more than one vertically extending rib 127 (broadly, strengthening member), to strengthen the tanks. The ribs 127 extend along the exterior of the fluid tanks 126A-C. In the illustrated embodiment, the ribs 127 are formed by deforming a portion of the fluid tank's 126A-C side walls (broadly, body) outward, although other configurations of the ribs may be used without departing from the scope of the present disclosure. The removeable fluid tanks 126A-C may also include fill level indicia 129 (FIG. 10) for visually indicating to an operator or user the amount or level of fluid within the fluid tank 126A-C. The fill level indicia 129 is disposed on the back or rear side of the fluid tank 126A-C and is arranged (broadly, at least a portion of the fill level indicia is arranged) to align with the corresponding window 136A-C in the shroud 134 (FIG. 7), so that the fill level indicia is visible to the operator when the removeable fluid tanks are secured to the housing 114. This allows the operator to quickly visually determine the amount of fluid in the fluid tanks 126A-C. In the illustrated embodiment, the fill level indicia 129 comprises multiple vertically spaced apart marks 131 (e.g., horizontal lines). Three marks 131 are employed, a lower mark 131 indicating ¼ full, a middle mark indicating ½ full, and an upper mark indicating ¾ full. More or fewer marks, and/or marks indicating other levels of full may be used without departing from the scope of the present disclosure. The marks 131 may be formed by any suitable method, such as by printing or forming the marks into the sides of the fluid tanks (similar to the ribs 127).

The embodiments of the fluid service assembly 10 of the present disclosure provides many advantages over conventional systems. The removeable fluid tanks 26A-C, 126A-C can be easily removed from the fluid service module 12, 112 without removing the fluid service module from the bed 4 of the service truck 2. This allows the fluid tanks 26A-C, 126A-C to be quickly replaced if the fluid service module 12, 112 needs to contain a different type of fluid. This also allows the fluid tanks 26A-C, 126A-C to be removed for easier cleaning. In addition, the hose reels 64A-D being separate from the fluid service module 12, 112 allows the hose reels to be mounted at a more convenient location on the service truck 2, such as on a fender portion 8A, 8B instead of in the truck bed 4. The reversing valve 68 also being separate from the fluid service module 12, 112 similarly allows the reversing valve to be mounted at a more convenient location. With the fluid tanks 26A-C, 126A-C being removable, the rest of the fluid service assembly 10 can typically remain within the truck bed 4 such that it may be less frequently removed (e.g., when the service truck 2 is being serviced, the fluid service assembly is being serviced, or otherwise). Thus, the fluid service assembly 10 is not ordinarily removed when being filled with fluids to go in the field or providing associated fluid services in the field.

Various ways of using the embodiments of the fluid service assembly 10 of the present disclosure will now be described. In typical operation, after the fluid service assembly 10 is mounted to the service truck 2, the operator will fill the removeable fluid tanks 26A-C, 126A-C with the desired fluid. The service truck 2 will then be driven to the piece of equipment needing to be serviced. The operator will use the pumps 50A-C and associated hose reels 64A-C to refill the piece of equipment with the desired fluid or fluids. If needed, the operator, with use the waste pump 50D to remove used or waste fluid from the piece of equipment. This may be done before refilling the piece of equipment with fluid. In some methods of operation, the operator may need to deliver a different fluid to a piece of equipment. In this case, the operator disconnects the shroud 34, 134 from the remainder of the housing 14, 114. The operator removes one or more than one of the removeable fluid tanks 26A-C, 126A-C containing the fluid to be replaced. The fluid in these one or more than one of the removeable fluid tanks 26A-C, 126A-C may remain in the tanks or be removed prior to removing the tanks. After, the operator places one or more than one new removeable fluid tank 26A-C, 126A-C in the fluid tank interior 28, 128. The one or more than one new remoaveable fluid tank 26A-C, 126A-C replaces the removed fluid tanks and occupies the space in the fluid tank interior 28, 128 previously occupied by the one or more than one removed fluid tanks. After the desired number of removeable fluid tanks 26A-C, 126A-C have been replaced, the shroud 34, 134 is reconnected to the remainder of the housing 34, 134, thereby securing the new removeable fluid tanks in the fluid tank interior 28, 128 of the housing. The new fluid tanks 26A-C, 126A-C can now be filled with fluid, such a fluid different than the fluid the removed fluid tanks held. This prevents cross-contamination of the different fluids. The service truck 2 can now travel to the piece of equipment and the new fluid can be pumped to the piece of equipment to service the piece of equipment. Following generally the same manner as replacing the removeable fluid tanks 26A-C, 126A-C, the removeable fluid tanks can be removed from the fluid service module 12, 112, cleaned, and then re-secured to the fluid service module. The embodiments of the fluid service assembly 10 of the present disclosure may be used and operated in other ways without departing from the scope of the present disclosure.

It is apparent that the elements, features, and/or teachings set forth in each embodiment disclosed herein are not limited to the specific embodiment(s) the elements, features and/or teachings are described in. Accordingly, it is understood that the elements, features and/or teachings described in one embodiment may be applied to one or more of the other embodiments disclosed herein, even if said elements, features and/or teachings where not described herein as being a part of said one or more of the other embodiments.

Modifications and variations of the disclosed embodiments are possible without departing from the scope of the invention defined in the appended claims. For example, where specific dimensions are given, it will be understood that they are exemplary only and other dimensions are possible.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A service vehicle comprising:
a service truck having a truck bed; and
a fluid service assembly comprising:
a fluid service module supported by the truck bed of the service truck, the fluid service module including:
a housing;
a first fluid tank removeably attached to the housing and having a first interior configured to contain a first fluid;
a first fluid pump supported by the housing, the first fluid pump being configured to pump the first fluid out of the first interior of the first fluid tank;
a waste fluid tank having a waste fluid interior configured to contain a waste fluid; and
a waste fluid pump associated with the waste fluid tank, the waste fluid pump being supported by the housing; and
a hose reel assembly coupled to the service truck independent of the fluid service module, the hose reel assembly including a first hose reel fluidly connected to the first fluid pump to receive the first fluid pumped by the first fluid pump.

2. The service vehicle of claim 1, wherein the hose reel assembly is disposed along a side of the truck bed.

3. The service vehicle of claim 2, wherein the hose reel assembly is mounted to a fender portion of the service truck.

4. The service vehicle of claim 1, wherein the fluid service module includes a second fluid tank removeably attached to the housing and having a second interior configured to contain a second fluid, the fluid service module including a second fluid pump supported by the housing, the second fluid pump being configured to pump the second fluid out of the second interior of the second fluid tank.

5. The service vehicle of claim 4, wherein the hose reel assembly includes a second hose reel fluidly connected to the second fluid pump to receive the second fluid pumped by the second fluid pump.

6. The service vehicle of claim 1, wherein the housing forms the waste fluid tank.

7. The service vehicle of claim 1, wherein the first fluid tank is made of plastic.

8. The service vehicle of claim 1, wherein the fluid service module is secured to the truck bed of the service truck with one or more than one fastener.

9. The service vehicle of claim 1, wherein hose reel assembly includes a hose reel housing containing the first hose reel, the hose reel housing mounted to the service truck.

10. A fluid service module comprising:
a housing including a fluid tank interior and a shroud bounding the fluid tank interior;
a first fluid tank disposed in the fluid tank interior and supported by the housing, the first fluid tank having a first interior configured to contain a first fluid; and
a first fluid pump attached to the housing, the first fluid pump being configured to pump the first fluid out of the first interior of the first fluid tank;
the shroud being releasably connectable to a remainder of the housing such that when the shroud is connected to the remainder of the housing the shroud secures the first fluid tank in the fluid tank interior of the housing and when the shroud is disconnected from the remainder of the housing the first fluid tank is removeable from the fluid tank interior of the housing.

11. The fluid service module of claim 10, wherein the shroud bounds at least one of the following: a first side of the fluid tank interior, a second side of the fluid tank interior, a rear of the fluid tank interior, or a top of the fluid tank interior.

12. The fluid service module of claim 10, wherein the shroud bounds at least two of the following: a first side of the fluid tank interior, a second side of the fluid tank interior, a rear of the fluid tank interior, or a top of the fluid tank interior.

13. The fluid service module of claim 10, wherein the shroud bounds a first side of the fluid tank interior, a second side of the fluid tank interior, a rear of the fluid tank interior, and a top of the fluid tank interior.

14. The fluid service module of claim 10, further comprising:
a second fluid tank disposed in the fluid tank interior and supported by the housing, the second fluid tank having a second interior configured to contain a second fluid; and
a second fluid pump attached to the housing, the second fluid pump being configured to pump the second fluid out of the second interior of the second fluid tank;
wherein when the shroud is connected to the remainder of the housing the shroud secures the second fluid tank in the fluid tank interior of the housing and when the shroud is disconnected from the remainder of the housing the second fluid tank is removeable from the fluid tank interior of the housing.

15. The fluid service module of claim 10, wherein the first fluid tank is translucent or transparent, and wherein the housing includes a window arranged to permit an operator to view a level of the first fluid in the first fluid tank.

16. The fluid service module of claim 15, wherein shroud include the window.

17. The fluid service module of claim 16, wherein the shroud includes fill level indicia configured to visually indicate a fill level of the first fluid within the first fluid tank.

18. The fluid service module of claim 10, further comprising a first heater configured to heat the first fluid in the first interior of the first fluid tank.

19. The fluid service module of claim 10, wherein the housing forms a waste fluid tank, and wherein the fluid service module further comprises a waste fluid pump associated with the waste fluid tank.

20. The fluid service module of claim 10, wherein the fluid service module is free of a hose reel fluidly connected to the first fluid pump for delivering the first fluid pumped out of the first fluid tank by the first fluid pump.

21. A fluid service module comprising:
a housing including a fluid tank interior and a shroud bounding the fluid tank interior, the housing forming a waste fluid tank;
a first fluid tank disposed in the fluid tank interior and supported by the housing, the first fluid tank having a first interior configured to contain a first fluid, the first fluid tank being translucent or transparent; and
a first fluid pump attached to the housing, the first fluid pump being configured to pump the first fluid out of the first interior of the first fluid tank;
a second fluid tank disposed in the fluid tank interior and supported by the housing, the second fluid tank having a second interior configured to contain a second fluid, the second fluid tank being translucent or transparent;
a second fluid pump attached to the housing, the second fluid pump being configured to pump the second fluid out of the second interior of the second fluid tank;
a third fluid tank disposed in the fluid tank interior and supported by the housing, the third fluid tank having a third interior configured to contain a third fluid, the third fluid tank being translucent or transparent;
a third fluid pump attached to the housing, the third fluid pump being configured to pump the third fluid out of the third interior of the third fluid tank; and
a waste fluid pump configured to pump waste fluid into and out of the waste fluid tank;
the shroud being releasably connectable to a remainder of the housing such that when the shroud is connected to the remainder of the housing the shroud secures the first, second, and third fluid tanks in the fluid tank interior of the housing and when the shroud is disconnected from the remainder of the housing the first, second, and third fluid tanks are removeable from the fluid tank interior of the housing, the shroud bounding at least two of the following: a first side of the fluid tank interior, a second side of the fluid tank interior, a rear of the fluid tank interior, or a top of the fluid tank interior;
the housing including a first window arranged to permit an operator to view a level of the first fluid in the first fluid tank, a second window arranged to permit the operator to view a level of the second fluid in the second fluid tank, and a third window arranged to permit the operator to view a level of the third fluid in the third fluid tank.

22. A method comprising:
disconnecting a shroud from a remainder of a housing of a fluid service module to access a first fluid tank configured to contain a first fluid;
removing, after said disconnecting, the first fluid tank from a fluid tank interior of the housing;
placing, after said removing, a second fluid tank in the fluid tank interior, the second fluid tank occupying a space in the fluid tank interior occupied by the first fluid tank before the first fluid tank was removed from the fluid tank interior; and
reconnecting, after said placing, the shroud to the remainder of the housing of the fluid service module to secure the second fluid tank in the fluid tank interior.

23. The method of claim 22, further comprising filling, after said placing, the second fluid tank with a second fluid different than the first fluid.

24. The method of claim 23, further comprising pumping, after said filling, the second fluid from the second fluid tank to a piece of equipment.
